(19) United States
(12) Patent Application Publication
(10) Pub. No.: US 2017/0004456 A1
(43) Pub. Date: Jan. 5, 2017

(54) SEARCH BY APPLICANT RANKER SCORES

(71) Applicant: LinkedIn Corporation, Mountain View, CA (US)

(72) Inventors: Yi Feng, Sunnyvale, CA (US); Mudit Goel, Sunnyvale, CA (US); Dong Li, Sunnyvale, CA (US); Yida Yao, San Jose, CA (US)

(21) Appl. No.: 15/158,398

(22) Filed: May 18, 2016

Related U.S. Application Data
(63) Continuation of application No. 14/788,672, filed on Jun. 30, 2015.

(51) Int. Cl. G06Q 10/10; G06F 3/0482; G06F 17/30

(52) U.S. Cl. CPC G06Q 10/1053; G06F 17/3053; G06F 17/30867; G06F 17/30377; G06F 3/0482; G06Q 50/01

(57) ABSTRACT

Disclosed in some examples are systems, methods, and machine-readable mediums which enhance the social networking service by providing a search functionality to allow members to search for jobs based upon their predicted applicant score or rank. Thus, a member may easily search for jobs in which the member is likely to compare favorably to others who have already applied. In order to maintain this data, the social networking service may utilize an event-driven live update architecture which allows the social networking service to manage these scores and update these scores based upon events (e.g., new job postings, new job applicants, and the like).

### RELATED APPLICATIONS

This application is a continuation of U.S. patent application Ser. No. 14/788,672, filed Jun. 30, 2015, which is incorporated herein by reference in its entirety.

### BACKGROUND

A social networking service is a computer or web-based service that enables users to establish links or connections with persons for the purpose of sharing information with one another. Some social network services aim to enable friends and family to communicate and share with one another, while others are specifically directed to business users with a goal of facilitating the establishment of professional networks and the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an example graphical user interface for a job posting according to some examples of the present disclosure.

FIG. 2 shows an example graphical user interface that enables users to search for job postings according to some examples of the present disclosure.

FIG. 3 shows a block diagram of the functional components of a social networking service according to some examples of the present disclosure.

FIG. 4 shows a more detailed block diagram of components from FIG. 3 according to some examples of the present disclosure.

FIG. 5 shows a flowchart of a method of returning job listings matching a search query where the search query includes search criteria specifying a predicted ranking of the user performing the search query according to some examples of the present disclosure.

FIG. 6 shows a flowchart of a method of handling a new job application event according to some examples of the present disclosure.

FIG. 7 shows a flowchart of a method of handling a new job posting event according to some examples of the present disclosure.

FIG. 8 shows a flowchart of a method of handling a deleted job posting event according to some examples of the present disclosure.

FIG. 9 shows a flowchart of a method of handling a new member event according to some examples of the present disclosure.

FIG. 10 illustrates a block diagram of an example machine upon which any one or more of the techniques discussed herein may be performed according to some examples of the present disclosure.

### DETAILED DESCRIPTION

In the following, a detailed description of examples will be given with references to the drawings. It should be understood that various modifications to the examples may be made. In particular, elements of one example may be combined and used in other examples to form new examples.

Many of the examples described herein are provided in the context of a social or business networking website or service. However, the applicability of the inventive subject matter is not limited to a social or business networking service. The present inventive subject matter is generally applicable to a wide range of information and networked services. Other networked services that are applicable to the current inventive subject matter include, but are not limited to, job posting networked services—where users can view or post resumes and employers can post job openings.

A social networking service is a type of networked service provided by one or more computer systems accessible over a network that allows members of the service to build or reflect social networks or social relations among members. Members may be individuals or organizations. Typically, members construct profiles, which may include personal information such as the member's name, contact information, employment information, photographs, personal messages, status information, multimedia, links to web-related content, blogs, and so on. In order to build or reflect the social networks or social relations among members, the social networking service allows members to identify, and establish links or connections with, other members. For instance, in the context of a business networking service (a type of social networking service), a member may establish a link or connection with his or her business contacts, including work colleagues, clients, customers, personal contacts, and so on. With a social networking service, a member may establish links or connections with his or her friends, family, or business contacts. While a social networking service and a business networking service may be generally described in terms of typical use cases (e.g., for personal and business networking respectively), it will be understood by one of ordinary skill in the art with the benefit of Applicant's disclosure that a business networking service may be used for personal purposes (e.g., connecting with friends, classmates, former classmates, and the like) as well as, or instead of, business networking purposes; and a social networking service may likewise be used for business networking purposes as well as or in place of social networking purposes. A connection may be formed using an invitation process in which one member “invites” a second member to form a link. The second member then has the option of accepting or declining the invitation.

In general, a connection or link represents or otherwise corresponds to an information access privilege, such that a first member who has established a connection with a second member is, via the establishment of that connection, authorizing the second member to view or access certain non-publicly available portions of their profiles that may include communications they have authored. Example communications may include blog posts, messages, “wall” postings, or the like. Of course, depending on the particular implementation of the business/social networking service, the nature and type of the information that may be shared, as well as the granularity with which the access privileges may be defined to protect certain types of data, may vary.

Some social networking services may offer a subscription or “following” process to create a connection instead of, or in addition to, the invitation process. A subscription or following model is where one member “follows” another member without the need for mutual agreement. Typically in this model, the follower is notified of public messages and other communications posted by the member that is followed. An example social networking service that follows this model is Twitter®—a micro-blogging service that allows members to follow other members without explicit permission. Other connection-based social networking services also may allow following-type relationships as well. For example, the social networking service LinkedIn® allows members to follow particular companies.

Social networking services may also provide the ability for members who are organizations to recruit, attract, and manage employees. For example, the social networking service may provide a Graphical User Interface (GUI) to allow these organizations the ability to upload or create job postings and accept job applications for those postings. When uploading or creating a job posting, the organization specifies information about the job opening. This information may include one or more qualifications that are required or desired for applicants, a description of the job, contact information, information about the company, and the like. Collectively, the set of information about a job opening, along with social network generated metadata (e.g., a unique Job ID), is referred to herein for convenience as a job posting. The social networking service may then store this job posting in a database.

The social networking service may also provide a GUI to job seekers (who may be members of the social networking service) to facilitate job searching by job seekers. In some examples, job seekers may utilize the GUI to submit the necessary information (e.g., a resume, contact information, writing sample, credentials and the like) to apply for the job. Some or all of the information submitted by the job seeker may be submitted to the organization that created the job posting.

The social networking profiles of applicants may contain data which may allow the job applicants to be scored as to how well they meet one or more of the qualifications for that job posting. Applicants may then be ranked relative to each other based upon their scores. For example, the social networking system may use these scores to determine the top 10% of applicants, top 25% of applicants, and top 50% of applicants, and so on. In some examples, these rankings may be provided to the organization that created the job posting, or to one or more members.

In some examples, applicant scores may be computed based upon one or more algorithms. One example algorithm is a textual similarity score that quantifies a similarity between an attribute in a field of the member profile of the applicant (or other information submitted in the job application) and a respective qualification from the set of qualifications for the job, such as, for example, a textual similarity between a job title attribute in the applicant's member profile and a job title in the job posting. In some examples, multiple textual similarity scores from comparisons between multiple fields of the applicant member's profile and multiple qualifications from the set of qualifications may be combined to yield the applicant score. Scores may be combined, for example, using a weighted summation of the individual comparisons.

The textual similarities may be computed by first calculating the term frequency and inverse document frequency (tf-idf) scores for each token in the profile field and the job qualification. Each token in the member profile field may then be represented as one dimension of a first vector with a magnitude that is the tf-idf score of that token, each token in the qualification may be represented as one dimension of a second vector with magnitude that is the tf-idf score of that qualification. The similarity between the two vectors may be calculated based upon a cosine similarity. This cosine similarity is a measure of how similar the member profile field and the qualification are. In other examples, more complicated similarity comparisons may be utilized such as a Lucene Practical Scoring Function.

In some examples, the social networking service may show members their applicant ranking without requiring the member to apply for the job. This ranking may be termed a “predicted ranking,” to distinguish these rankings from the actual rankings calculated for the actual applicants. The predicted ranking represents a ranking that the member would receive, should the member apply for the job, at the time that the predicted ranking is calculated. The predicted rank is calculated by scoring a member who has not applied for the job posting in the same way as described above for those members who have applied, and comparing this score to scores of other members who have applied. This allows members to gauge how well they would fare against those who have already applied in order to target their applications to job postings in which they have a likelihood of success.

Predicting the rankings for a single job posting is computationally inexpensive as each time a member visits a job posting, the score and percentiles may be computed on the fly. However, it may be beneficial to allow members to directly search for job postings based upon their rankings. In order to allow for this search to happen in a timely manner (so as not to annoy users), the member's scores for all jobs needs to be maintained and updated as needed. This data would need to be updated based upon a number of events including new job postings, new applicants to job postings, and so on. Given the size of modern social networking services, with many topping 300 million members and having millions of job postings and even more applicants, this becomes a challenging computational task to manage.

Disclosed in some examples are systems, methods, and machine-readable mediums which enhance the social networking service by providing an efficient and scalable search functionality to allow members to search for jobs based upon their applicant score and/or predicted rank. This system allows a member to easily search for jobs in which the member is likely to compare favorably to others who have already applied, while at the same time utilizing a minimum of computing resources. In order to maintain the data needed to allow for a fast search response time, the social networking service may utilize an event-driven live update architecture that allows the social networking service to manage member scores and predicted rankings and update these scores and predicted rankings based upon events (e.g., new job postings, new job applicants, and the like) that impacts these scores and predicted rankings.

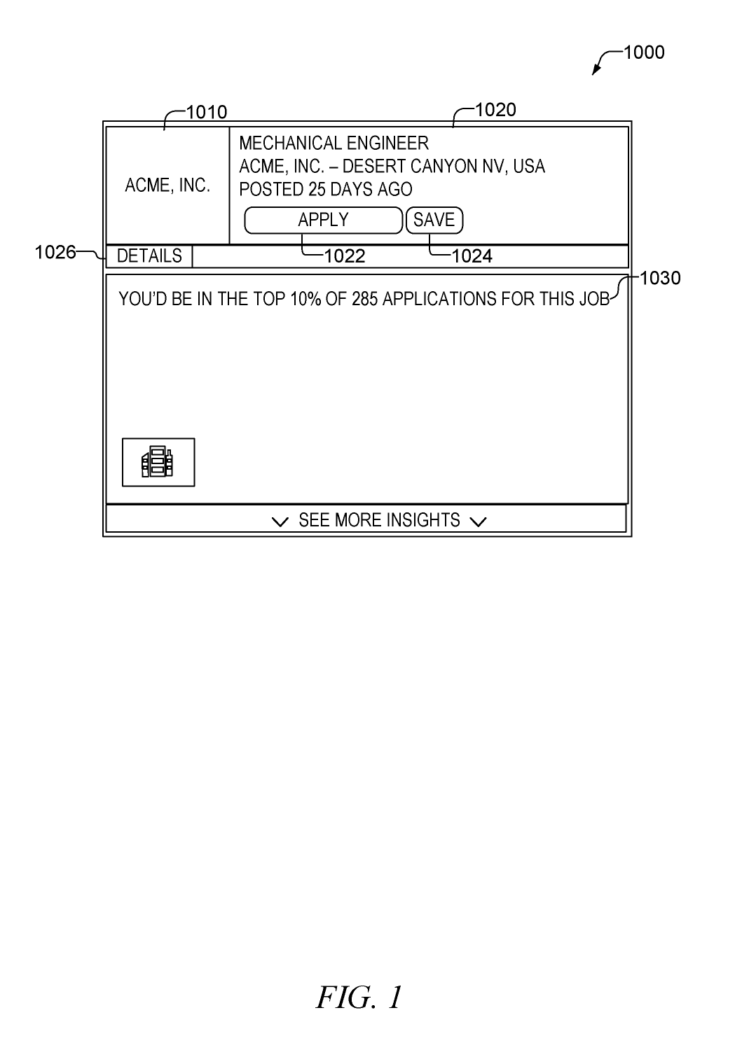

Turning now to FIG. 1, an example graphical user interface (GUI) 1000 created and provided by the social networking service for a job posting is shown. The name of the company, “Acme, Inc.,” is shown in the GUI 1000 at location 1010. Location 1010 may include a company logo in addition to or instead of the company name. Job information, including location, title, and when the job was posted, is shown at location 1020 of the GUI 1000. Button 1022, when activated, allows users to apply for the job. In some examples, users will be taken to a different user interface, either on the company's own website, or on the social networking server which may provide one or more form fields which, when filled out and submitted, sends an electronic application for the job posting. Button 1024, when activated, may save the job in a “favorites” section of the user's member profile for quick retrieval later. Button 1026, when activated, may present additional job details. At location 1030, the member's predicted ranking (shown as a percentile) is displayed in the GUI 1000. Here, the social networking service is telling the member that if the member applies, the member would be in the top 10% of applicants. This predicted ranking is calculated by scoring the member profile of the user against one or more of the job qualifications corresponding to the posting, and then comparing the user's score with the scores for all applicants who have already applied.

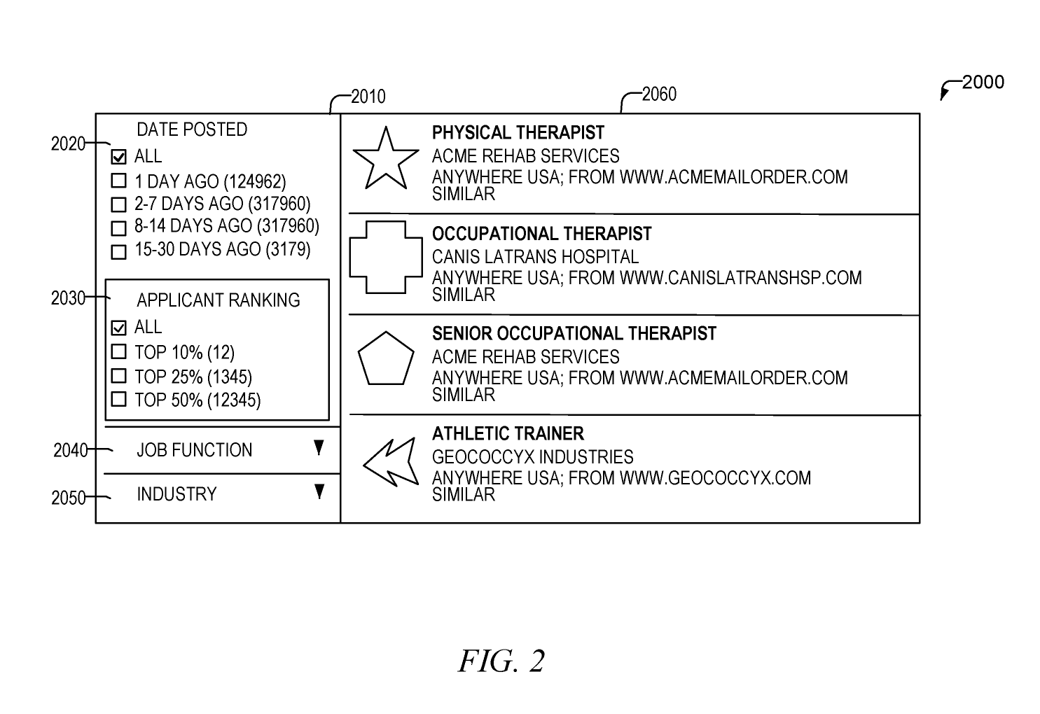

Turning now to FIG. 2, an example GUI 2000 that is created by, and provided by, the social networking service that enables a member to search for job postings is shown. Search options box 2010 may allow the user to specify one or more search criteria. As used herein for convenience, “criteria” comprises one or more criterion. For example, at location 2020 the user can specify search criteria for how recent the returned job postings should be. At location 2040, the user can expand the panel to reveal options to specify search criteria related to certain job functions. At location 2050, the user can expand the panel to reveal industry search criteria. At location 2030, the user may specify predicted ranking search criteria such that the social networking service returns job postings in which the social networking service predicts the user would rank in the top 10%, top 25%, or top 50% of current applicants. Next to each ranking category, the number of jobs meeting that criteria is listed in parenthesis. While the disclosure herein refers to the percentile thresholds as 10%, 25%, 50%, one of ordinary skill in the art with the benefit of Applicants' disclosure will appreciate that any percentile threshold may be utilized. Multiple different criteria may be entered: for example, the user may select jobs posted 1 day ago where the member has a predicted ranking of top 10%. In these examples, the criteria are “AND”ed together such that job postings need to meet both criteria. In other examples, one or more other logical operators may be used in any combination to combine the criteria (e.g., “OR,” “XOR,” “NOT” and the like).

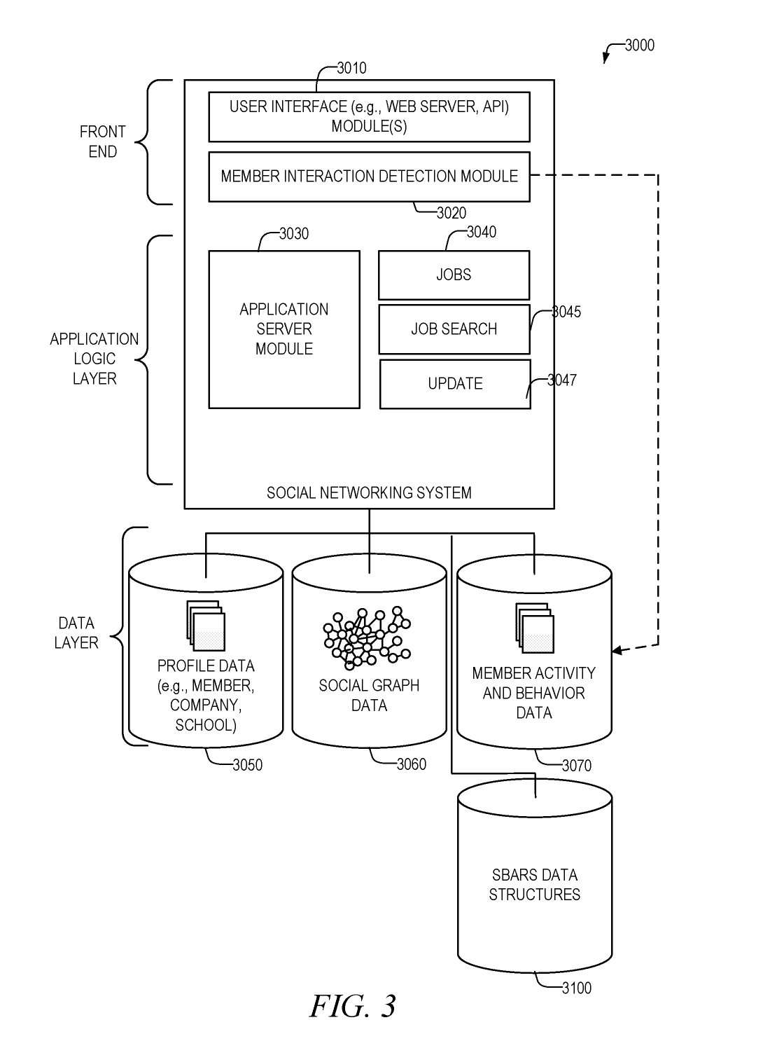

FIG. 3 is a block diagram showing the functional components of a social networking service 3000. As shown in FIG. 3, a front end module may comprise a user interface module (e.g., a web server) 3010, which receives requests from various client-computing devices, and communicates appropriate responses to the requesting client devices. For example, the user interface module(s) 3010 may receive requests in the form of Hypertext Transport Protocol (HTTP) requests, or other network-based, application programming interface (API) requests (e.g., from a dedicated social networking service application running on a client device). In addition, a member interaction and detection module 3020 may be provided to detect various interactions that members have with different applications, services and content presented. As shown in FIG. 3, upon detecting a particular interaction, the member interaction and detection module 3020 logs the interaction, including the type of interaction and any meta-data relating to the interaction, in the member activity and behavior database 3070.

An application logic layer may include one or more various application server modules 3030, which, in conjunction with the user interface module(s) 3010, generate various graphical user interfaces (e.g., web pages) with data retrieved from various data sources in the data layer. With some embodiments, application server module 3030 is used to implement the functionality associated with various applications and/or services provided by the social networking service as discussed above.

Application logic layer may also include jobs module 3040 which, in conjunction with application server module 3030, user interface modules 3010, job search module 3045, and update module 3047, provide the ability to post jobs, view jobs, search jobs, apply for jobs, and the like via one or more user interfaces provided by jobs module 3040 to users of the social networking service 3000. Job search engine 3045, in conjunction with jobs module 3040, may provide the ability for users to search job postings based upon one or more search criteria. Criteria include job function, date the job was posted, job locations, job titles, job pay, company, industry, skills required for the job, job score, and a predicted ranking. The predicted ranking criteria specify a predicted rank the searching member must be in order for the job posting to be returned as a search result. For example, the predicted ranking criteria may specify that the searching member be in the top 10%, 20%, 25%, 50%, and the like, as compared to the current job applicants. In other examples, the ranking criteria may not be a percentage, but instead may be a threshold rank, such as, for example, the top 10, 20, 30, 50, or 100 applicants. Job search module 3045 may integrate with jobs module 3040 to provide this enhancement to the job search functionality.

Update module 3047 may maintain and update a number of data structures, referred to herein for descriptive convenience as Search-By-Applicant-Rank (SBARS) data structures 3100, which track the predicted and actual rankings and include an index or indices that are used by job search module 3045 to search for job postings based upon the member's predicted ranking. Example SBARS data structures 3100 include one or more of a JobId-ApplicantList data structure, a JobPosting-Member data structure, and one or more search indices. The JobId-ApplicantList data structure may store information on the applicants for each job posting, indexed by a unique Job Id assigned to each job posting. The JobPosting-Member data structure may store, for each Job Id, each member's score and their predicted ranking (e.g., a percentile or an actual ranking). The SBARS data structures 3100, including the search indices, are detailed more in the discussion that follows. These data structures may be stored and maintained by one or more modules in the application logic layer, such as jobs module 3040, job search module 3045, and update module 3047.

SBARS data structures 3100 may be part of a data layer which may include several other databases, such as a database 3050 for storing profile data, including both member profile data as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 3050. Similarly, when a representative of an organization initially registers the organization with the social networking service, the representative may be prompted to provide certain information about the organization. This information may be stored, for example, in the database 3050, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Information describing the various associations and relationships, such as connections that the members establish with other members, or with other entities and objects, is stored and maintained within a social graph in the social graph database 3060. Also, as members interact with the various applications, services, and content made available via the social networking service, the members' interactions and behavior (e.g., content viewed, links or buttons selected, messages responded to, etc.) may be tracked and information concerning the member's activities and behavior may be logged or stored, for example, as indicated in FIG. 3 by the member activity and behavior database 3070.

With some embodiments, the social networking service 3000 provides an application programming interface (API) module with the user interface module 3010 via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

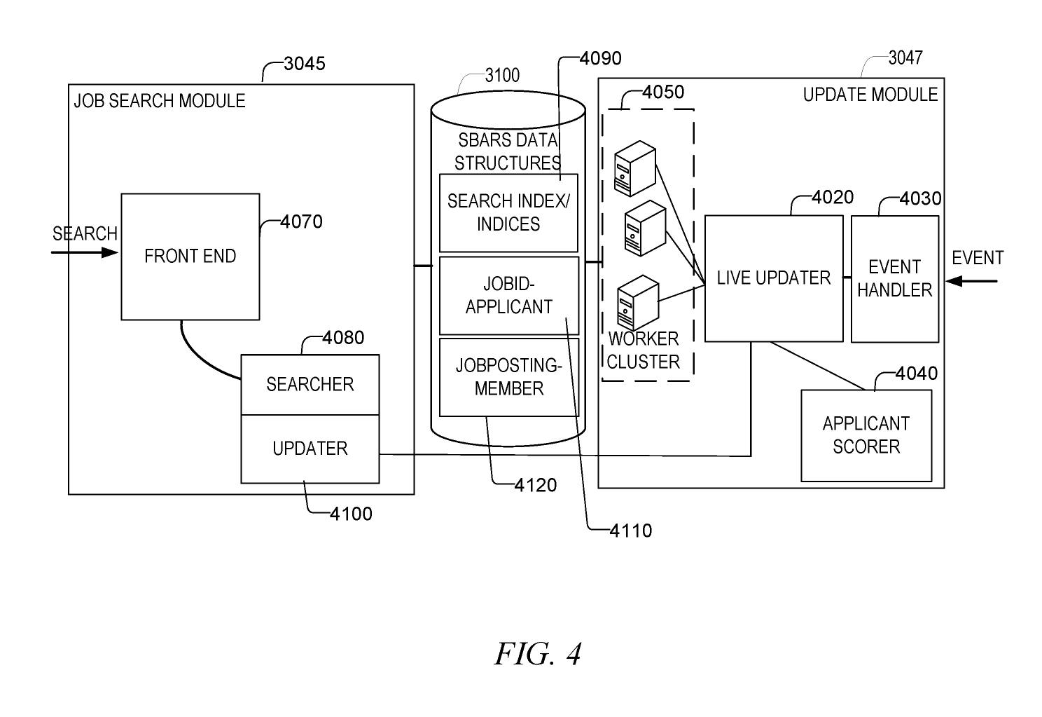

FIG. 4 shows a more detailed diagram of the job search module 3045 and the update module 3047 of FIG. 3. Job search module 3045 may return job postings that match predicted ranking search criteria. Job search module 3045 may include a front end module 4070 for the receipt and dispatch of search queries and the return of search results to users. Searches are routed to a searcher module 4080, which may use one or more indices, such as search index/indices 4090, and as will be explained later, may use an update list, to generate results to pass back to front end module 4070. Updater 4100 communicates with live updater module 4020 to receive updates to the indices, such as search index/indices 4090.

As noted above, the update module 3047 may update one or more SBARS data structures 3100, such as search index/indices 4090, JobId-Applicant List data structure 4110, and JobPosting-Member data structure 4120. In some examples, where the ranking criteria comprises a plurality of predefined groups (e.g., top 10%, top 25%, top 50%), search index/indices 4090 may store, for each member in the social networking service, a list of each job posting in each ranking group. For example, a schema for search index/indices 4090 may be of the form:

<Member ID X>: Top 10%
A LIST OF:
   <JOB ID, APPLICANT SCORE>

<Member ID X>: Top 25%
A LIST OF:
   <JOB ID, APPLICANT SCORE>

<Member ID X>: Top 50%
A LIST OF:
   <JOB ID, APPLICANT SCORES>
      Thus, for each member, there are separate lists of Job Ids for each of the possible ranking groups. When searching, the searcher module 4080 may then use the member id of the member that is searching along with the ranking criteria as an index into the data structure to retrieve the list of jobs that meet the search criteria from the search index/indices 4090. As can be appreciated, the search index is structured to efficiently search for job postings that match ranking criteria.

As already noted, one or more of the indices used to search for the set of job postings meeting the ranking criteria will need to be updated based upon certain types of events, such as, for example, a new job application may be received for an existing job posting. In this case, if the new applicant's score is higher than a particular member's score for that job posting, then that particular member's predicted ranking will need to be updated in the indices. In any case, the update module 3047 will need to determine what, if any, updates are necessary.

Update module 3047 may include an event handler module 4030, which receives events, such as new job postings, new job applications, and the like, and dispatches them to the live updater module 4020. Live updater module 4020 processes the events to update the SBARS data structures 3100. Live updater module 4020 also makes use of worker cluster 4050 for this task. Worker cluster 4050 is a distributed computing cluster. Applicant scorer module 4040 implements the scoring algorithms (e.g., the cosine similarity algorithms) in order to return a score for a particular applicant given the job posting.

As already noted, the search index is structured to efficiently search for job postings that match ranking criteria. The search index, however, is not structured to efficiently update the rankings based upon new members, new job applicants, or the like. Indeed, to update the search index based upon these events using just the search index would require iterating through large portions of the index. Moreover, allowing the index to be updated in-place would render the index unavailable for long periods. Given the frequency with which these changes are likely to occur in a social networking system, this inefficiency and index down-time may be substantial.

Rather than update the search index directly, the live updater module 4020 uses its own separate data structures and then generates a list of changes to be applied to the search index. The searcher module 4080 than uses this update list along with the search index to respond to search queries. The data structures used by the live updater module 4020 include the JobPosting-Member data structure 4120. The JobPosting-Member data structure 4120 may store, for each Job Id, each member's score and each member's predicted ranking. For example, the JobPosting-Member data structure may data such as:

### <Job Id>

a LIST OF <Member Id, Score, Predicted Ranking>

This data structure is structured in a way that efficiently allows for updates to the rankings generated by events such as a new job applicant or a new member. Unlike the search index/indices 4090, which is optimized for search, this data structure allows for quick updates following a new job application and a new member. In the case of a new job applicant, the system just needs to pull the list corresponding to the Job Id of the job to access every member's predicted rankings and then update them. In the case of a new member, the system only has to insert a new member in the list for each Job Id. The JobPosting-Member data structure may then be used to update the search index periodically.

Search index/indices 4090 may comprise multiple indices, such as, for example, a live index in memory and a base index on disk. The live index comprises the latest updates sent from the update module 3047 (e.g., the update list). Periodically, the live index may be merged with the base index. When searcher module 4080 searches for the SBARS set, the searcher module 4080 may search both the live and base index. Results from both are then merged (e.g., any change reflected in the live index would override any result in the base index). The base index may be periodically built (e.g., daily) so its content may be out of date, thus the live index is also used which keeps all the changes that have not yet been reflected in the base index that have occurred during the day.

In yet other examples, the search index/indices 4090 may comprise a base index, which is stored on disk and rebuilt periodically. A live index resides in memory and stores any changes since the base index was rebuilt. Finally, a snapshot index stores a snapshot of the live index to disk so that the snapshot is saved in the event of a power outage.

The specific interactions between the modules of the update module 3047, the job search module 3045 and the SBARS data structures 3100 will be discussed with reference to the method flowcharts that follow.

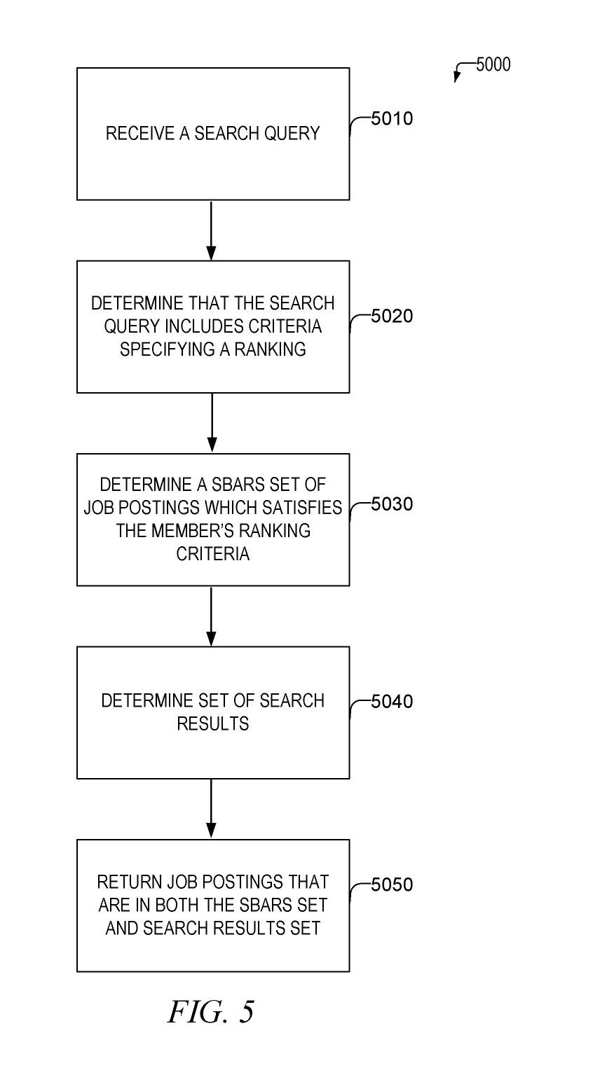

FIG. 5 shows a flowchart of a method 5000 of returning job listings matching a search query where the search query includes search criteria specifying a predicted ranking for the user performing the search query. At operation 5010, the social networking service receives the search query. In some examples, this may be the front end module 4070 of the job search module 3045. At operation 5020 the social networking service determines that the search query includes search criteria specifying a predicted ranking. Predicted ranking search criteria may be a percentile cutoff (e.g., top 10%, 25%, 50%), a percentile range (e.g., 5-10%), a threshold comparison of scores (e.g., top 10 scores), a threshold score value (e.g., a score above 1000), or the like. Operations 5010 and 5020 may be performed by front end module 4070, or some other component (e.g., a component outside job search module 3045, or a component of job search module 3045 that is not shown).

At operation 5030, the searcher module 4080 may determine a first set of job postings, referred to herein for descriptive convenience as a Search By Applicant Ranker Score (SBARS) set of job postings which satisfies the member's predicted ranking criteria using the search index/indices 4090. This set of job postings are job postings where the searching member's predicted ranking criteria matches the searching member's predicted rank.

At operation 5040 the other search criteria are evaluated and jobs meeting that search criteria are determined. This may be done by searcher module 4080 or another module in job search module 3045 (such as front end module 4070, or a module not shown) or another module on the social networking service (outside job search module 3045). At operation 5050 the results returned at 5030 and 5040 may comprise the union of the SBARS set and the set of search results from operation 5040. This union may be calculated by front end module 4070, or a module not shown in FIG. 4 and is returned at operation 5050.

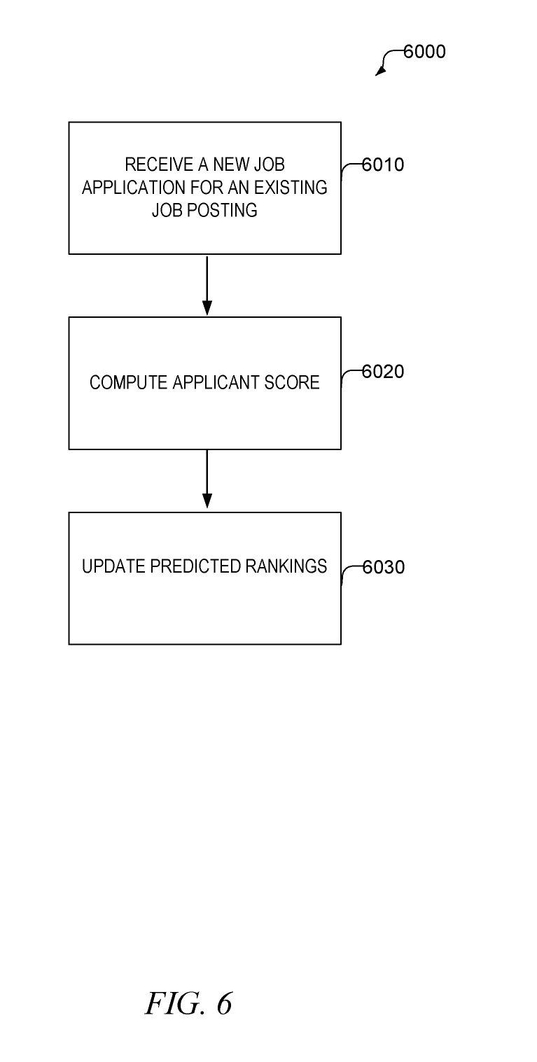

Turning now to FIG. 6, a method 6000 of handling a new job application event is shown. At operation 6010 the update module 3047 may receive an event indicating a new job application has been submitted for an existing job posting. In some examples, the event may include data describing the job application. In some examples, the event is received through an event handler module 4030. The event handler module 4030 may determine that the event is to be forwarded to the live updater module 4020. Live updater module 4020 may send information about the applicant (such as the applicant's member profile, data describing the job application, or both) to the applicant scorer module 4040. At operation 6020, applicant scorer module 4040 uses this information to score the applicant on how well the applicant meets the job posting's criteria. This score and ranking may then be passed back to live updater module 4020.

Live updater module 4020 may add this applicant to the list of applicants under the Job Id of the job posting in the JobId-Applicant list data structure 4110. The JobId-Applicant list data structure 4110 may store a list of applicants and their scores for each active job posting. Live updater module 4020 may also include the applicant's score in the JobId-Applicant list data structure 4110. At operation 6030, the live updater module 4020 may then update the predicted rankings for the members.

The JobPosting-Member data structure may be partitioned such that each machine in the worker cluster 4050 has a partition assigned to it. In some examples, live updater module 4020 may send an identical, percentile-cut list to each machine in the worker cluster 4050. Each worker cluster 4050 may retrieve the Job Id in its partition of the data structure and calculate the new percentiles. The changes may then be sent back to the live updater module 4020. Live updater 4020 may then compose an update instruction list and updates the search index/indices 4090 (e.g., the live index).

For example, suppose that the current JobId-ApplicantList[1234] was [<0.999,1111>, <0.932,1112>, <0.900,1113>, <0.890,1114>, <0.700, 1115>, <0.632,1116>, <0.600,1117>, <0.515,1118>, <0.310, 1119>], where the first number in each pair is the score and the second number is the member id. Given this list, if a member wants to be in the top 10%, his or her applicant score must be greater than or equal to 0.999. If the member wants to be in the top 25%, then his/her score must be greater than or equal to 0.932, and greater than or equal to 0.700 in order to be in the top 50%.

Now suppose a member with Member ID 321 submits an application for a job posting with JobId of 1234, and the applicant scorer module 4040 returns an applicant score of 0.881. Once the new applicant is added, the JobId-ApplicantList[1234] is updated to be [<0.999,1111>, <0.932,1112>, <0.900,1113>, <0.890,1114>, <0.881, 321>, <0.700, 1115>, <0.632,1116>, <0.600,1117>, <0.515,1118>, <0.310, 1119>]. In this case the new percentile-cut list, assuming percentiles of 10, 25, and 50%, distributed to the worker cluster 4050, is {1234: {10:[0.999], 25: [0.932], 50: [0.881]}, where 1234 is the Job Id, 0.999 is the 10% cutting score, 0.932 is the 25% cutting score, and 0.881 is the top 50% cutting score. Each machine in the worker cluster will receive a copy of the percentile-cut list.

Prior to updating, assume that the JobPosting-Member data structure for job 1234, JobPosting-Member[1234], is [<123, 0.999, 10>, <234, 0.800, 50>, <345, 0.937, 25>], where in each 3-tuple <X,Y,Z> X is a member Id, Y is the score for the member with id X, and Z is that member's ranking. The new percentiles would be [<123, 0.999, 10>, <234, 0.800, 100>, <345, 0.937, 25>]. As can be appreciated, the new applicant bumped member 234 from the top 50% (represented by top 100%), and bumped member 345 from the top 25% to the top 50%. This is represented by changes sent from the worker cluster 4050 to the live updater module 4020. Live updater module 4020 aggregates these changes and sends an update instruction list to the updater module 4100. Updater module 4100 periodically updates the search index/indices 4090. In between updates, the searcher module 4080 may utilize both the search index/indices 4090 and one or more update instruction lists sent by live updater module 4020. An example update instruction list may be: [<234,50, 100>, <345,25,50>] where in each tuple <A,B,C> A is the member ID, B is the old percentile, and C is the new percentile. In some examples, the update instruction may be stored in a live index, and when the searcher module 4080 searches both the live and base indices, any results from the base indices may be changed based upon the change lists for the live index. Note that any instruction lists from live updater module 4020 that change other, previously sent instruction lists may be merged in the live index by updater module 4100.

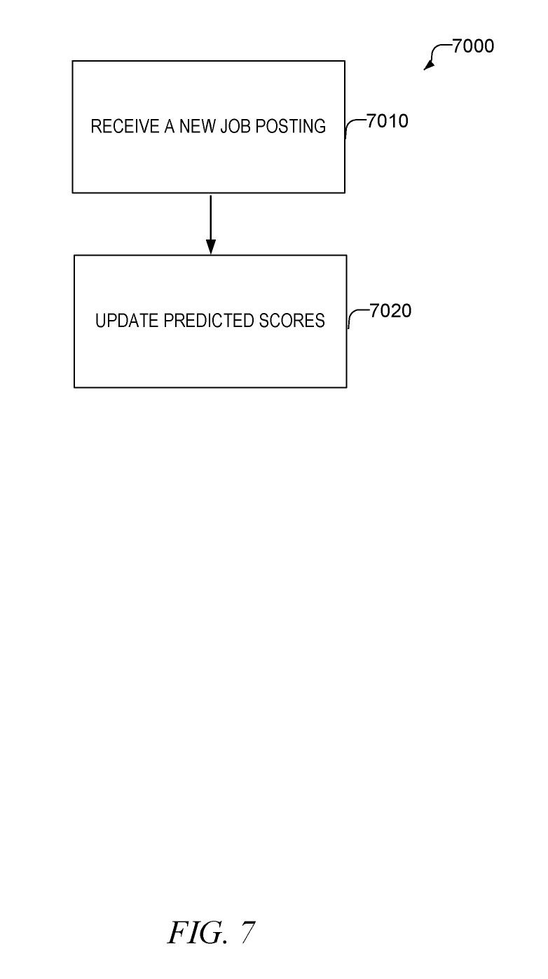

The live updater module 4020 may also handle other events, such as, for example, a new job posting submitted by an organization. Turning now to FIG. 7, a flowchart of a method 7000 of handling a new job posting event is shown. At operation 7010 the event handler module 4030 may receive a notification of a new job posting. The event handler module 4030 may notify the live updater module 4020, which may insert the new job posting into the JobId-Applicant list data structure 4110 with no applicants. At operation 7020 the social networking system may determine the scores of all members for that job. The live updater module 4020 may submit each member to the applicant scorer module 4040 to receive their scores. These scores are inserted into the JobPosting-Member data structure 4120. Since the job has no applicants yet, the predicted ranking of each member is fixed at 100% or some other suitable ranking until a sufficient amount of job applicants have been received. In some examples, this is ten applicants. Once ten applicants are received, each member's predicted rankings will need to be processed as in operation 6030 in FIG. 6.

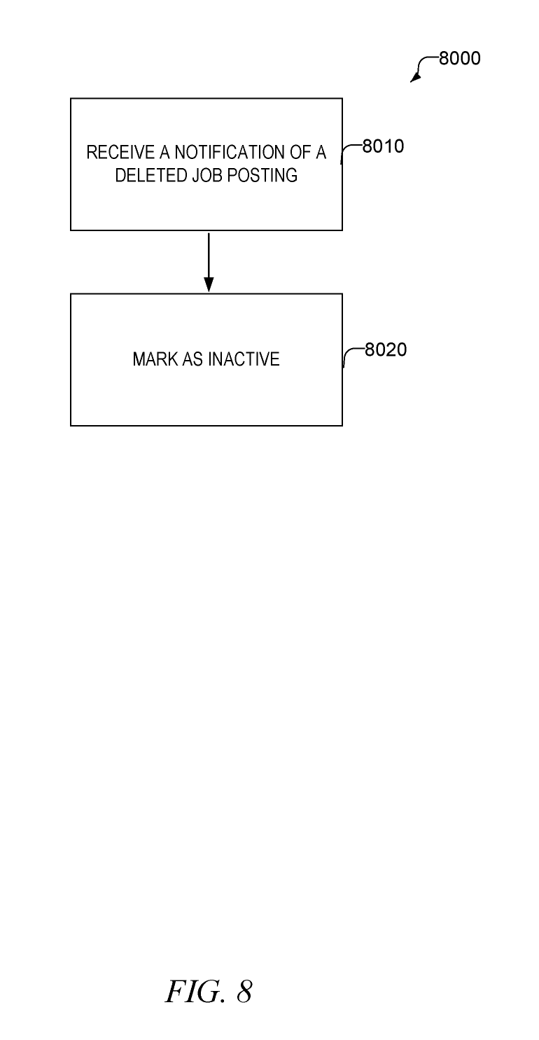

Turning now to FIG. 8, a flowchart of a method 8000 of handling a deleted job posting event is shown. At operation 8010 the event handler module 4030 may receive a notification of a deleted job posting. The event handler module 4030 may notify the live updater module 4020, which may mark the JobId as inactive in various data structures such as search index/indices 4090, JobId-Applicant list data structure 4110 and JobPosting-Member data structure 4120 at operation 8020.

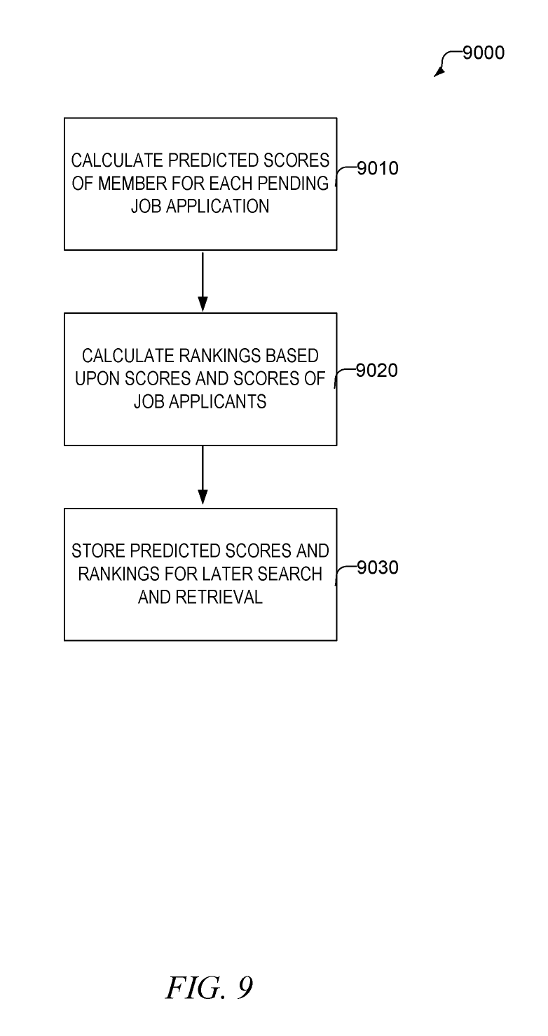

Turning now to FIG. 9, a flowchart of a method 9000 of handling a new member event is shown. At operation 9010 the event handler module 4030 may receive a notification of a new member of the social networking service. In some examples, rather than providing the predicted rankings to all members, only select groups of members may be provided the predicted rankings. For example, the social networking service may reserve this feature for members in exchange for a fee (e.g., a premium member). In these examples, the notification may be for a new premium member.

The event handler module 4030 may notify the live updater module 4020, which calls the applicant scorer module 4040 for each job posting in the system to calculate the scores at operation 9010. At operation 9020 the live updater module 4020 may calculate the ranking of the new member in each job posting's applicant list (e.g., using the JobId-Applicant list data structure 4110). At operation 9030 the live updater module 4020 may store the scores and predicted rankings for later search and retrieval. For example, live updater module 4020 may call the worker cluster 4050 to update the scores in the JobPosting-Member data structure 4120. Live updater module 4020 may also update the search index/indices 4090 (e.g., the live index).

In some examples, the initial process of populating the SBARS data structures 3100 initially may run the operations of FIG. 9 for all members (or all members in the selected group).

The live updater module 4020 may also handle deletions of members. The live updater module 4020 may mark the member as deleted in the worker cluster 4050, which may remove all records of the user in the search index/indices 4090, JobId-Applicant list data structure 4110, and the JobPosting-Member data structure 4120.

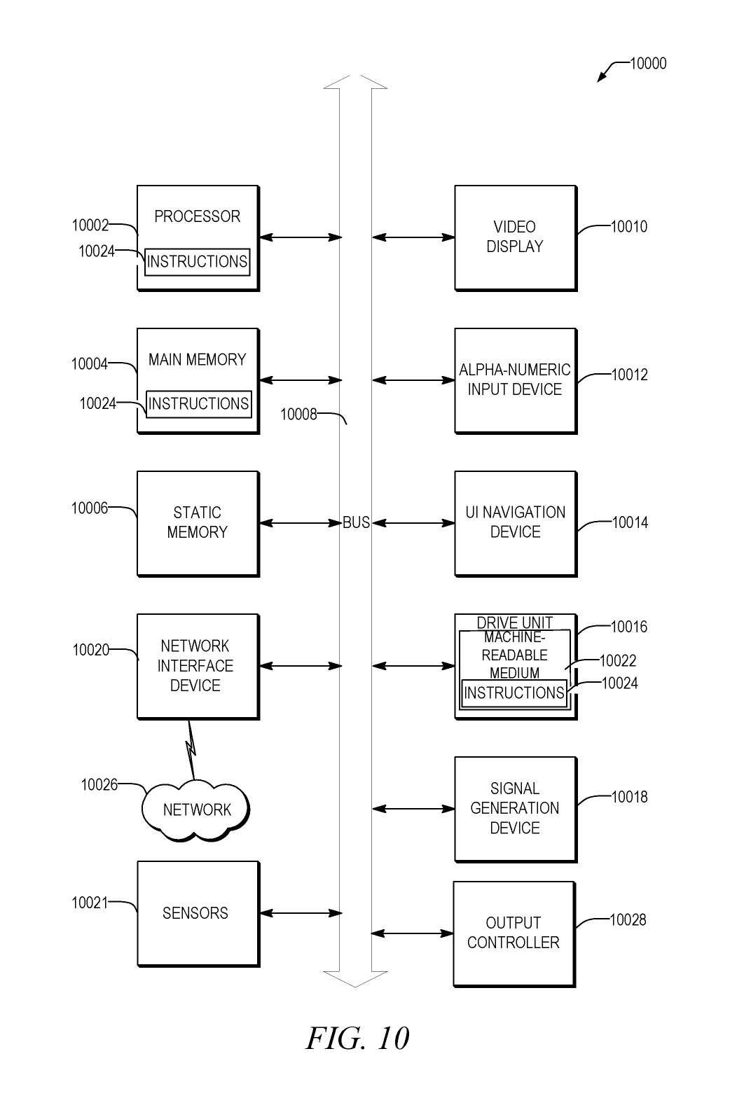

FIG. 10 illustrates a block diagram of an example machine 10000 upon which any one or more of the techniques (e.g., methodologies) discussed herein may be performed. For example machine 10000 may one or more of: create the GUIs of FIGS. 1-2, be configured as shown in FIG. 3-4, and execute the methods of FIGS. 5-9. In alternative embodiments, the machine 10000 may operate as a standalone device or may be connected (e.g., networked) to other machines. In a networked deployment, the machine 10000 may operate in the capacity of a server machine, a client machine, or both in server-client network environments. In an example, the machine 10000 may act as a peer machine in peer-to-peer (P2P) (or other distributed) network environment. The machine 10000 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 10000 may include a hardware processor 10002 (e.g., a central processing unit (CPU), a graphics processing unit (GPU), a hardware processor core, or any combination thereof), a main memory 10004 and a static memory 10006, some or all of which may communicate with each other via an interlink (e.g., bus) 10008. The machine 10000 may further include a display unit 10010, an alphanumeric input device 10012 (e.g., a keyboard), and a user interface (UI) navigation device 10014 (e.g., a mouse). In an example, the display unit 10010, input device 10012 and UI navigation device 10014 may be a touch screen display. The machine 10000 may additionally include a storage device (e.g., drive unit) 10016, a signal generation device 10018 (e.g., a speaker), a network interface device 10020, and one or more sensors 10021, such as a global positioning system (GPS) sensor, compass, accelerometer, or other sensor. The machine 10000 may include an output controller 10028, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 10016 may include a machine-readable medium 10022 on which is stored one or more sets of data structures or instructions 10024 (e.g., software) embodying or utilized by any one or more of the techniques or functions described herein. The instructions 10024 may also reside, completely or at least partially, within the main memory 10004, within static memory 10006, or within the hardware processor 10002 during execution thereof by the machine 10000. In an example, one or any combination of the hardware processor 10002, the main memory 10004, the static memory 10006, or the storage device 10016 may constitute machine-readable media.

While the machine-readable medium 10022 is illustrated as a single medium, the term “machine readable medium” may include a single medium or multiple media (e.g., a centralized or distributed database, and/or associated caches and servers) configured to store the one or more instructions 10024.

The term “machine readable medium” may include any medium that is capable of storing, encoding, or carrying instructions (e.g., instructions 10024) for execution by the machine 10000 and that cause the machine 10000 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine-readable media may include non-transitory machine-readable media. In some examples, machine-readable media may include machine-readable media that is not a transitory propagating signal.

The instructions 10024 may further be transmitted or received over a communications network 10026 using a transmission medium via the network interface device 10020. The machine 10000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 10020 may include one or more physical jacks (e.g., Ethernet, coaxial, or phone jacks) or one or more antennas to connect to the communications network 10026. In an example, the network interface device 10020 may include a plurality of antennas to wirelessly communicate using at least one of single-input multiple-output (SIMO), multiple-input multiple-output (MIMO), or multiple-input single-output (MISO) techniques. In some examples, the network interface device 10020 may wirelessly communicate using Multiple User MIMO techniques.

1.-21. (canceled)

22. A method of increasing a responsiveness and availability of an electronic job ranking search functionality, the method comprising a plurality of electronic operations, performed by processing circuitry of a computing device, comprising:
determining for each particular one of a plurality of online job postings that a member of a networking service has not applied to, a predicted ranking of the member based upon a score of the member and scores calculated for members of the networking service who have already applied for the particular one of the plurality of online job postings, the scores quantifying how well the member meets one or more qualifications of the particular one of the plurality of online job postings by comparing one or more fields in a member profile of the member with one or more qualifications corresponding to the particular one of the plurality of online job postings;
storing the predicted ranking for each particular one of the plurality of online job postings that the member has not applied to in a first data structure in a memory of the computing device, the first data structure indexed by an identifier corresponding to each particular one of the plurality of online job postings and storing, for each one of the plurality of online job postings, a list of a plurality of data structures, each containing:
a member identifier, a corresponding score, and a corresponding predicted ranking;
creating a search index based upon the first data structure, the search index indexed by a member identifier and predicted ranking, the search index storing a set of identifiers corresponding with the plurality of online job postings;
receiving a new job applicant event indicating a second member has applied to a first one of the plurality of online job postings;
responsive to receiving the new job applicant event, updating the predicted ranking of the member for the first one of the plurality of online job postings in the first data structure by accessing the first data structure using an identifier corresponding to the first one of the plurality of online job postings and updating the ranking of the member based upon a score of the second member for the first one of the plurality of online job postings;
determining an update list data structure for updating the search index based upon the search index and the first data structure, the update list data structure indexed by an identifier corresponding to the first one of the plurality of online job postings and storing changes in rankings for members;
prior to an operation merging the search index and the update list, receiving a search query from the member through a first graphical user interface (GUI) provided by the networking service, the search query specifying a predicted ranking criteria;
responsive to receiving the search query:
identifying a first set of online job postings that satisfies the predicted ranking criteria for the member by searching the search index using an identifier of the member and the predicted ranking criteria specified in the search query;
identifying a change to the predicted ranking of a job in the first set of online job postings by traversing the update list data structure and in response, modifying the first set of online job postings to reflect the change; and
creating a second GUI for the member, the second GUI listing at least one of the first set of online job postings; and
periodically merging the search index and the update list.

23. The method of claim 22, wherein the electronic operations comprise:
determining that the search query includes an additional search criteria that is not the predicted ranking criteria;
selecting a second set of online job postings that match the additional search criteria; and
wherein creating the second GUI for the member comprises selecting the at least one of the first set of online job postings based upon determining that the at least one of the first set of online job postings is present in both the first and second sets of online job postings.

24. The method of claim 22, wherein the operation of determining the predicted ranking is performed for all members of the networking service.

25. The method of claim 22, wherein the electronic operations comprise:
receiving an event for a new online job posting;
responsive to determining that a minimum amount of members of the networking service have applied to the new online job posting, calculating for the new online job posting a predicted ranking for the member;
storing the predicted ranking for the new online job posting for the member in the first data structure; and
determining a second update list data structure for updating the search index based upon the search index and the first data structure, the second update list data structure indexed by an identifier corresponding to the first one of the plurality of online job postings and storing changes in rankings for members.

26. The method of claim 25, wherein the electronic operations comprise:
receiving a second search query from the member specifying a second predicted raking criteria;
responsive to receiving the second search query:
identifying a second set of online job postings that satisfies the second predicted ranking criteria for the member by searching the search index using an identifier of the member and the second predicted ranking criteria specified in the second search query;
identifying a second change to the predicted ranking of one of the plurality of online job postings in the second set of online job postings by traversing the second update list data structure and in response, modifying the second set of job postings to reflect the second change; and
creating a third GUI for the member, the third GUI listing at least one of the second set of job postings; and
merging the search index and the second update list.

27. The method of claim 22, wherein the operations of determining the predicted ranking, storing the predicted ranking, updating the predicted ranking of the member responsive to receiving the new job applicant event, and determining the update list data structure are done in real-time or near real-time, and wherein the operations of creating the search index, and merging the search index and the update list are done periodically.

28. A computing device comprising:
a non-transitory computer readable medium having instructions stored thereon, which, when executed by a processor, causes the processor to perform the operations of:
determining for each particular one of a plurality of online job postings that a member of a networking service has not applied to, a predicted ranking of the member based upon a score of the member and scores calculated for members of the networking service who have already applied for the particular one of the plurality of online job postings, the scores quantifying how well the member meets one or more qualifications of the particular one of the plurality of online job postings by comparing one or more fields in a member profile of the member with one or more qualifications corresponding to the particular one of the plurality of online job postings;
storing the predicted ranking for each particular one of the plurality of online job postings that the member has not applied to in a first data structure in a memory of the computing device, the first data structure indexed by an identifier corresponding to each particular one of the plurality of online job postings and storing, for each one of the plurality of online job postings, a list of a plurality of data structures, each containing:
a member identifier, a corresponding score, and a corresponding predicted ranking;
creating a search index based upon the first data structure, the search index indexed by a member identifier and predicted ranking, the search index storing a set of identifiers corresponding with the plurality of online job postings;
receiving a new job applicant event indicating a second member has applied to a first one of the plurality of online job postings;
responsive to receiving the new job applicant event, updating the predicted ranking of the member for the first one of the plurality of online job postings in the first data structure by accessing the first data structure using an identifier corresponding to the first one of the plurality of online job postings and updating the ranking of the member based upon a score of the second member for the first one of the plurality of online job postings;
determining an update list data structure for updating the search index based upon the search index and the first data structure, the update list data structure indexed by an identifier corresponding to the first one of the plurality of online job postings and storing changes in rankings for members;
prior to an operation merging the search index and the update list, receiving a search query from the member through a first graphical user interface (GUI) provided by the networking service, the search query specifying a predicted ranking criteria;
responsive to receiving the search query:
identifying a first set of online job postings that satisfies the predicted ranking criteria for the member by searching the search index using an identifier of the member and the predicted ranking criteria specified in the search query;
identifying a change to the predicted ranking of a job in the first set of online job postings by traversing the update list data structure and in response, modifying the first set of online job postings to reflect the change; and
creating a second GUI for the member, the second GUI listing at least one of the first set of online job postings; and
periodically merging the search index and the update list.

29. The computing device of claim 28, wherein the operations comprise:
determining that the search query includes an additional search criteria that is not the predicted ranking criteria;
selecting a second set of online job postings that match the additional search criteria; and
wherein the operations of creating the second GUI for the member comprise the operations of selecting the at least one of the first set of online job postings based upon a determination that the at least one of the first set of online job postings is present in both the first and second sets of online job postings.

30. The device of claim 28, wherein the operations of determining the predicted ranking are performed for all members of the networking service.

31. The device of claim 28,
wherein the operations comprise:
receiving an event for a new online job posting;
responsive to determining that a minimum amount of members of the networking service have applied to the new online job posting, calculating for the new online job posting a predicted ranking for the member;
storing the predicted ranking for the new online job posting for the member in the first data structure; and
determining a second update list data structure for updating the search index based upon the search index and the first data structure, the second update list data structure indexed by an identifier corresponding to the first one of the plurality of online job postings and storing changes in rankings for members.

32. The device of claim 31, wherein the operations comprise:
receiving a second search query from the member specifying a second predicted raking criteria;
responsive to receiving the second search query:
identifying a second set of online job postings that satisfies the second predicted ranking criteria for the member by searching the search index using an identifier of the member and the second predicted ranking criteria specified in the second search query;
identifying a second change to the predicted ranking of one of the jobs in the second set of online job postings by traversing the second update list data structure and in response, modifying the second set of job postings to reflect the second change; and
creating a third GUI for the member, the third GUI listing at least one of the second set of job postings; and
merging the search index and the second update list.

33. The device of claim 28, wherein the operations of determining the predicted ranking, storing the predicted ranking, updating the predicted ranking of the member responsive to receiving the new job applicant event, and determining the update list data structure are done in real-time or near real-time, and wherein the operations of creating the search index, and merging the search index and the update list are done periodically.

34. A non-transitory, machine-readable medium comprising instructions, which when performed by a machine, cause the machine to perform operations comprising:
determining for each particular one of a plurality of online job postings that a member of a networking service has not applied to, a predicted ranking of the member based upon a score of the member and scores calculated for members of the networking service who have already applied for the particular one of the plurality of online job postings, the scores quantifying how well the member meets one or more qualifications of the particular one of the plurality of online job postings by comparing one or more fields in a member profile of the member with one or more qualifications corresponding to the particular one of the plurality of online job postings;
storing the predicted ranking for each particular one of the plurality of online job postings that the member has not applied to in a first data structure in a memory of the computing device, the first data structure indexed by an identifier corresponding to each particular one of the plurality of online job postings and storing, for each one of the plurality of online job postings, a list of a plurality of data structures, each containing:
a member identifier, a corresponding score, and a corresponding predicted ranking;
creating a search index based upon the first data structure, the search index indexed by a member identifier and predicted ranking, the search index storing a set of identifiers corresponding with the plurality of online job postings;
receiving a new job applicant event indicating a second member has applied to a first one of the plurality of online job postings;
responsive to receiving the new job applicant event, updating the predicted ranking of the member for the first one of the plurality of online job postings in the first data structure by accessing the first data structure using an identifier corresponding to the first one of the plurality of online job postings and updating the ranking of the member based upon a score of the second member for the first one of the plurality of online job postings;
determining an update list data structure for updating the search index based upon the search index and the first data structure, the update list data structure indexed by an identifier corresponding to the first one of the plurality of online job postings and storing changes in rankings for members;
prior to an operation merging the search index and the update list, receiving a search query from the member through a first graphical user interface (GUI) provided by the networking service, the search query specifying a predicted ranking criteria;
responsive to receiving the search query:
identifying a first set of online job postings that satisfies the predicted ranking criteria for the member by searching the search index using an identifier of the member and the predicted ranking criteria specified in the search query;
identifying a change to the predicted ranking of a job in the first set of online job postings by traversing the update list data structure and in response, modifying the first set of online job postings to reflect the change; and
creating a second GUI for the member, the second GUI listing at least one of the first set of online job postings; and
periodically merging the search index and the update list.

35. The non-transitory, machine-readable medium of claim 34, wherein the operations comprise:
determining that the search query includes an additional search criteria that is not the predicted ranking criteria;
selecting a second set of online job postings that match the additional search criteria; and
wherein the operations of creating the second GUI for the member comprises selecting the at least one of the first set of online job postings based upon determining that the at least one of the first set of online job postings is present in both the first and second sets of online job postings.

36. The non-transitory, machine-readable medium of claim 34, wherein the operations of determining the predicted ranking are executed for all members of the networking service.

37. The non-transitory, machine-readable medium of claim 34, wherein the
operations comprise:
receiving an event for a new online job posting;
responsive to determining that a minimum amount of members of the networking service have applied to the new online job posting, calculating for the new online job posting a predicted ranking for the member;
storing the predicted ranking for the new online job posting for the member in the first data structure; and
determining a second update list data structure for updating the search index based upon the search index and the first data structure, the second update list data structure indexed by an identifier corresponding to the first one of the plurality of online job postings and storing changes in rankings for members.

38. The non-transitory, machine-readable medium of claim 19,
wherein the operations comprise:
receiving a second search query from the member specifying a second predicted raking criteria;
responsive to receiving the second search query:
identifying a second set of online job postings that satisfies the second predicted ranking criteria for the member by searching the search index using an identifier of the member and the second predicted ranking criteria specified in the second search query;
identifying a second change to the predicted ranking of one of the jobs in the second set of online job postings by traversing the second update list data structure and in response, modifying the second set of job postings to reflect the second change; and
creating a third GUI for the member, the third GUI listing at least one of the second set of job postings; and
merging the search index and the second update list.

39. The non-transitory, machine-readable medium of claim 34,
wherein the operations of determining the predicted ranking, storing the predicted ranking, updating the predicted ranking of the member responsive to receiving the new job applicant event, and determining the update list data structure are done in real-time or near real-time, and wherein the operations of creating the search index, and merging the search index and the update list are done periodically.
